(19) United States
(12) Patent Application Publication
(10) Pub. No.: US 2002/0171622 A1
(43) Pub. Date: Nov. 21, 2002

(54) Method for increasing resolution of mouse movement on screen

(76) Inventors: Yao-Sheng Shen, Taipei (TW); Ken-Pei Hu, Taipei Hsien (TW)

Correspondence Address: BACON & THOMAS, PLLC, 625 Slaters Lane, 4th Floor, Alexandria, VA, 22314-1176, US

(21) Appl. No.: 09/855,509

(22) Filed: May 16, 2001

(51) Int. Cl. G09G 5/00

(52) U.S. Cl. 345/156; 345/163

(57) ABSTRACT

A process for increasing resolution of mouse movement on computer screen comprises the steps of moving a mouse to cause two beams of light emitted from light emitting elements to be detected by photodetectors, converting the light into two sequential sinusoidal analog signals having a phase difference therebetween, activating an analog-to-digital converter (ADC) to perform an analog-to-digital conversion on the analog signals with respect to at least three predetermined references respectively, generating a series of integer in response to each analog signal passes two adjacent ones of the references, representing the series of integer as a step wave having a plurality of steps each representing an integer, and creating a coordinate comparison table with respect to the integers of the step wave, whereby there are at least six chances to determine change of coordinate with respect to a cursor moving on the screen during one movement cycle of the mouse.

### FIELD OF THE INVENTION

The present invention relates to computer mouse and more particularly to a method for increasing resolution of mouse movement on screen.

### BACKGROUND OF THE INVENTION

The major components of a conventional mouse 10 and diagrams for illustrating the operating characteristics thereof are shown in FIGS. 1 to 6. The mouse 10 comprises a ball 101, two grating mechanisms 102 each including a grating disc 122 coupled to one end of a roller 112 and perpendicular thereto and each roller 112 rotatably contacting ball 101 such that a rotation of ball 101 may cause roller 112 and thus grating disc 122 to rotate, two photosensor devices 103 each adjacent to grating mechanism 102 and including two light emitting elements 113 and two photodetectors 123 with grating disc 122 located therebetween, and a control circuit 104 electrically connected to photosensor devices 103. In use, grating disc 122 is rotated as ball 101 is rotated. Further, light emitted from light emitting elements 113 passes through the rotating grates of grating disc 122 to be detected by photodetectors 123. The detected signals are sent to control circuit 104. And in turn the signals are sent to central processing unit (CPU) on an electronic device (e.g., mainboard of computer) coupled to mouse 10. The signals are processed in CPU for generating a cursor control output including direction and distance of cursor moved on an output device 14 (e.g., computer screen coupled to the electronic device) for showing the position of cursor on the output device 14.

Typically, light emitted from light emitting elements 113 detected by photodetectors 123 is converted into sinusoidal analog signals (e.g., potential signals) by photodetectors 123 (FIGS. 2a, 2b, 3a, 3b and 6). Analog signals are further converted into digital signals by analog-to-digital converter (ADC) 15 of the electronic device with respect to predetermined high and low levels by the activated control circuit 104. In detail, the sinusoidal signal passing the high level while higher than the low level is converted into a digital signal represented by a binary value (e.g., 1). Likewise, the sinusoidal signal passing the low level while lower than the high level is converted into a digital signal represented by another binary value (e.g., 0). As a result, a digital output is generated in output device 14.

As known that the position of cursor on screen may be represented by values on X and Y axes, i.e., coordinate. Also, cursor moves a distance proportional to the movement of mouse. Hence, the position of cursor may be controlled by the movement of mouse 10. In a prior technique, control parameters associated with the movement of mouse are classified as pixel control parameters each representing corresponding pixels of a moving cursor on screen when mouse moves a unit distance and coordinate control parameters each representing corresponding coordinate of the moving cursor on screen when mouse moves a unit distance. Typically, for changing the moving speed of mouse on screen, user can program the mouse driver for changing a predetermined movement ratio of mouse with respect to cursor. Once the unit distance of the mouse movement is changed, the corresponding pixels are changed accordingly. As a result, the distance of mouse has to move for causing cursor to move from a first position to a second position on screen is reduced.

As to the control of coordinate of cursor, photosensor devices 103 of mouse 10 are activated to detect the movement of ball 101 in X and Y axes. An appropriate distance is set between two sets of corresponding light emitting elements 113 and photodetectors 123. Thus there is a phase difference between two sequentially generated sinusoidal signals in photodetectors 123 due to the rotation of grating of grating disc 122. In the example of photosensor device 103 detecting a movement of mouse 10 with respect to X axis, a sinusoidal signal X1 is generated by one photodetector 123 of photosensor device 103 (FIG. 2a) and another sinusoidal signal X2 is generated by the other photodetector 123 of photosensor device 103 (FIG. 2b). The signals X1 and X2 are further converted into digital representations as shown in FIGS. 3a and 3b respectively by ADC 15. The digital representations of FIGS. 3a and 3b may be illustrated in coordinate comparison tables of FIGS. 4 and 5 respectively. In FIG. 4, as ball 101 moves along X-axis to the left a cyclic set containing four coordinate values (0,0)→(1,0)→(1,1)→(0,1) plus returning to (0,0) is generated with respect to (X1, X2). In contrast as shown in FIG. 5, as ball 101 moves along X-axis but to the right another cyclic set containing four coordinate values (0,0)→(0,1)→(1,1)→(1,0) plus returning to (0,0) is generated with respect to (X1, X2). In view of above, there are four chances to determine the change of coordinate with respect to the range of pixel of cursor moving on screen during one mouse movement cycle.

Recently, the price of a monitor with high resolution and large screen is reduced significantly. Hence, more people, especially users involved in computer graphics and computer aided design, desire to buy such monitor due to high quality produced works and less frequent eye fatigue after a long time of use. But user is required to frequently move cursor from one position to the other position on screen. Thus user typically programs the mouse driver for changing a predetermined movement ratio of mouse with respect to cursor. For example, if the number of pixels of a high resolution screen is two times as that of a low resolution screen once mouse moves a unit distance the movement distance of cursor on the high resolution screen is only half of that on the low resolution screen. It is also possible to change above ratio for causing the number of pixels of cursor moved on screen to be double with respect to one unit movement of mouse. This can cause a movement distance of cursor observed on the high resolution screen to be the same as that on the low resolution screen under the condition of same screen size. But there is no improvement to above fact, i.e., there are only four chances to determine the change of coordinate with respect to the range of pixel of cursor moving on screen during one mouse movement cycle. To the worse, the number of pixels required to determine a change of coordinate of cursor is double. This may cause a high resolution screen user to be incapable of positioning cursor on screen precisely, thus lowering the resolution of mouse movement on screen.

### SUMMARY OF THE INVENTION

It is thus an object of the present invention to provide a process for increasing resolution of a mouse movement on a computer screen, the process comprising the steps of a) moving a mouse to cause two beams of light emitted from light emitting elements to be detected by photodetectors; b) converting the light into two sequential sinusoidal analog signals having a phase difference therebetween; c) activating an analog-to-digital converter (ADC) to perform an analog-to-digital conversion on the analog signals with respect to at least three predetermined references respectively; d) generating a series of integer in response to each analog signal passes two adjacent ones of the references; e) representing the series of integer as a step wave having a plurality of steps each representing an integer; and f) creating a coordinate comparison table with respect to the integers of the step wave, whereby there are at least six chances to determine change of coordinate with respect to a cursor moving on the screen during one movement cycle of the mouse.

The above and other objects, features and advantages of the present invention will become apparent from the following detailed description taken with the accompanying drawings.

### BRIEF DESCRIPTION OF THE DRAWINGS

FIG. 1 is a perspective view of the interior of a conventional mouse;

FIG. 2a is a diagram of a sinusoidal signal generated by one photodetector of photosensor device;

FIG. 2b is a diagram of a sinusoidal signal generated by the other photodetector of photosensor device;

FIG. 3a is a diagram of digital representation of FIG. 2a;

FIG. 3b is a diagram of digital representation of FIG. 2b;

FIG. 4 is a coordinate table representing a cyclic set containing binary values generated when ball moving along X-axis to the left;

FIG. 5 is a coordinate table representing a cyclic set containing binary values generated when ball moving along X-axis to the right;

FIG. 6 is a block diagram illustrating the signal detecting, conversion and output performed by the FIG. 1 mouse;

FIG. 7a is a diagram of square wave representation of a signal generated by a first preferred embodiment of method according to the invention;

FIG. 7b is a diagram of square wave representation of another signal generated by the first preferred embodiment of FIG. 7a;

FIG. 8 is a coordinate table representing a cyclic set containing integer values generated when ball moving along X-axis to the left or right of the first preferred embodiment;

FIG. 9 is a block diagram illustrating the signal detecting, conversion and output performed by a mouse according to the invention;

FIG. 10a is a diagram of a signal having triangular waveforms generated by one photodetector of photosensor device employed by a second preferred embodiment of method according to the invention;

FIG. 10b is a diagram of a signal having triangular waveforms generated by the other photodetector of photosensor device employed by the method illustrated in FIG. 10a;

FIG. 11a is a diagram of square wave representation of FIG. 10a;

FIG. 11b is a diagram of square wave representation of FIG. 10b; and

FIG. 12 is a coordinate table representing a cyclic set containing integer values generated when ball moving along X-axis to the left or right of the second preferred embodiment.

### DETAILED DESCRIPTION OF THE PREFERRED EMBODIMENTS

The invention relates to a process for increasing resolution of mouse movement on computer screen comprises the steps of moving a mouse to cause two beams of light emitted from light emitting elements to be detected by photodetectors, converting the light into two sequential sinusoidal analog signals having a phase difference therebetween, activating an analog-to-digital converter (ADC) to perform an analog-to-digital conversion on the analog signals with respect to at least three predetermined references respectively, generating a series of integer in response to each analog signal passes two adjacent ones of the references, representing the series of integer as a step wave having a plurality of steps each representing an integer, and creating a coordinate comparison table with respect to the integers of the step wave, whereby there are at least six chances to determine change of coordinate with respect to a cursor moving on the screen during one movement cycle of the mouse.

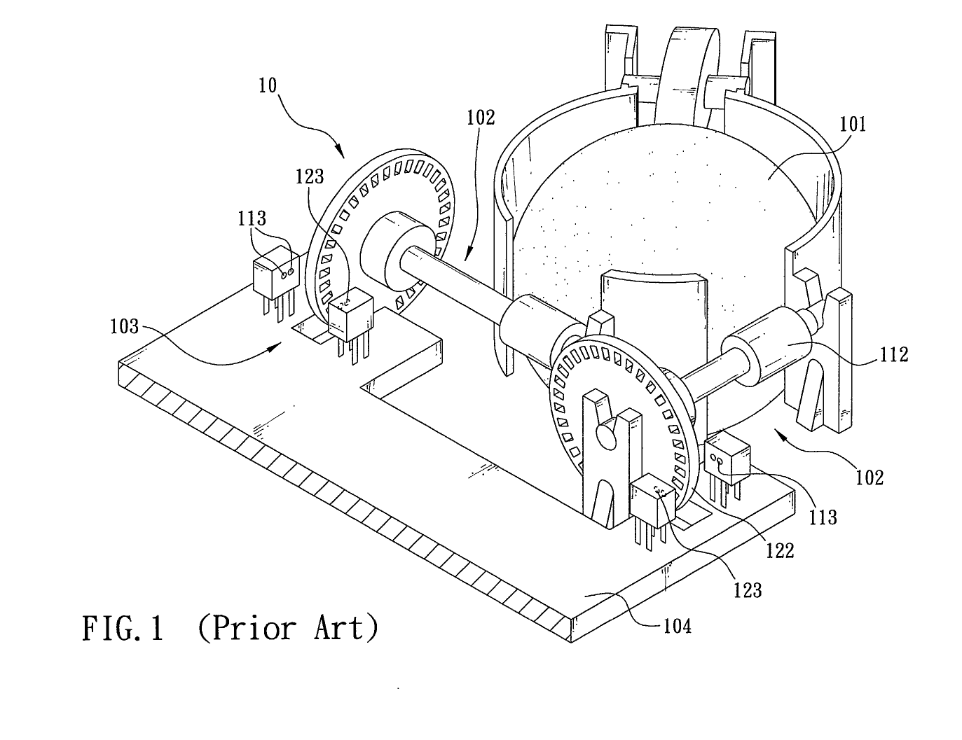

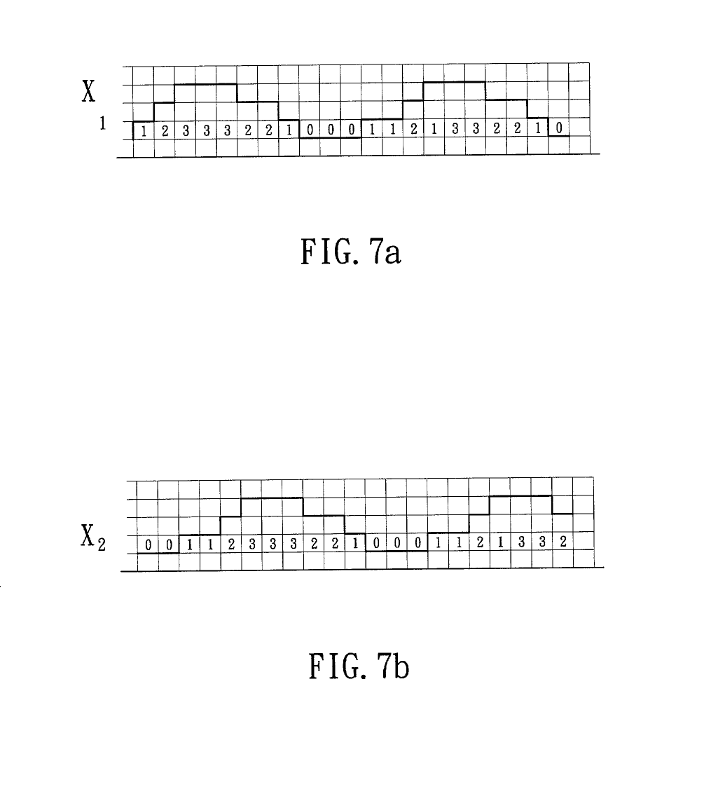

A first preferred embodiment of method in accordance with the invention is illustrated in FIGS. 7 to 9. When mouse moves, again referring to FIG. 1, two beams of light emitted from light emitting elements 113 are detected by photodetectors 123. Then the light is converted into two sequential sinusoidal signals (i.e., analog signals having predetermined amplitudes) having a phase difference therebetween. Referring to FIG. 9, such analog signals are further sent to ADC 23. Then ADC 23 performs an analog-to-digital conversion on the analog signals with respect to four predetermined references provided by control circuit 24. An integer is generated when the analog signal passes two adjacent references. Hence, a series of integer is generated in response to the analog signal. That is, a square wave is generated. This may be best illustrated in FIGS. 7a and 7b with respect to signals X1 and X2 respectively. Further, a coordinate comparison table is created with respect to above values in FIGS. 7a and 7b.

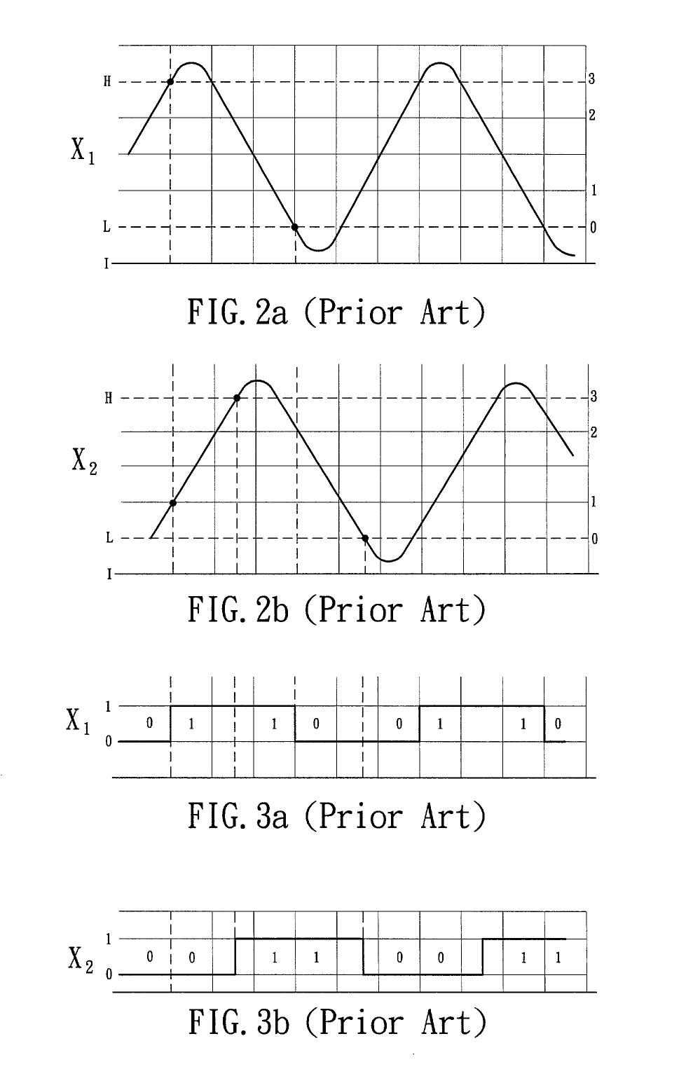

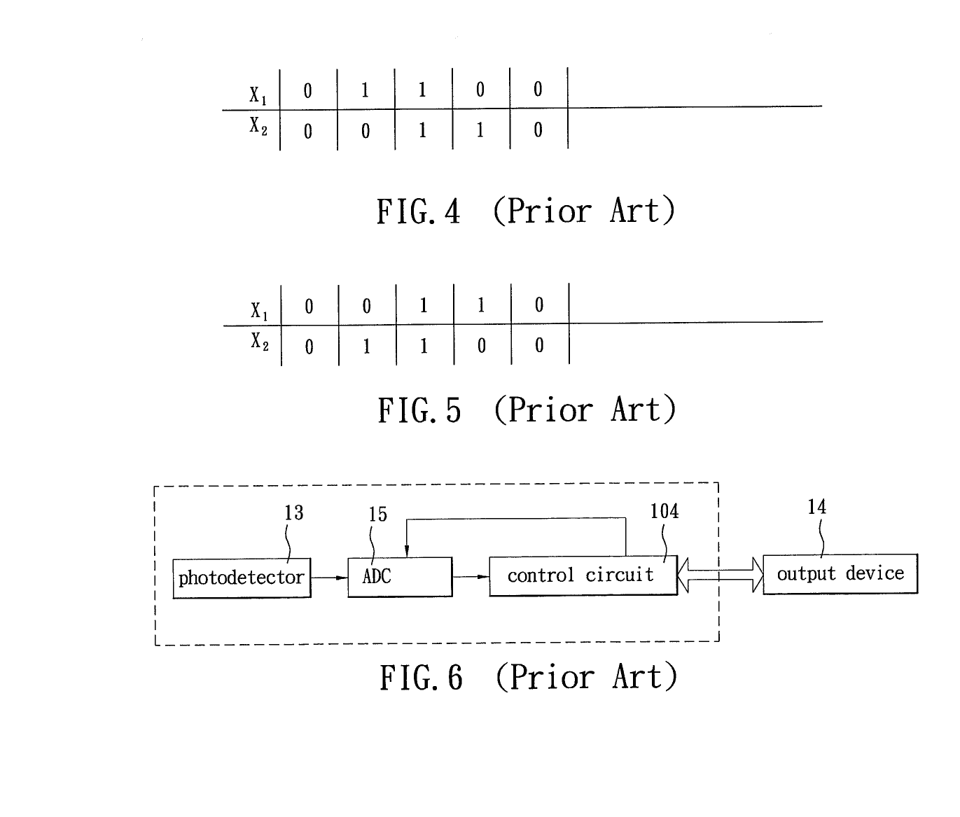

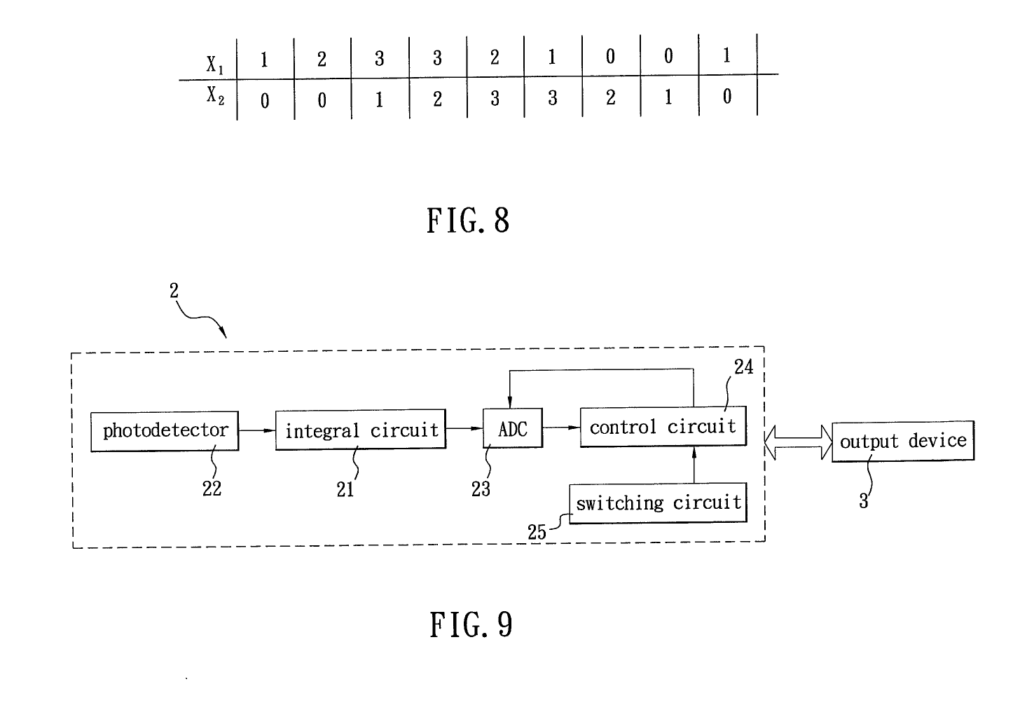

As shown, in the case that photodetectors 123 detect a movement of mouse with respect to X axis, a sinusoidal signal X1 is generated by one photodetector 123 of photosensor device 103 (FIG. 2a) and another sinusoidal signal X2 is generated by the other photodetector 123 of photosensor device 103 (FIG. 2b). The signals X1 and X2 are further converted into digital representations with respect to four predetermined references. Hence, a series of integer (i.e., square wave) is generated in response to each of the signals X1 and X2 as illustrated in FIGS. 7a and 7b. Further, a coordinate comparison table is created in FIG. 8 with respect to above values in FIGS. 7a and 7b. Referring to the table, as ball 101 moves along X-axis to the left a cyclic set containing eight coordinate values (1,0)→(2,0)→(3,1)→(3,2)→(2,3)→(1,3)→(0,2)→(0,1)→ . . . is generated with respect to (X1, X2). In contrast, as ball 101 moves along X-axis to the right a cyclic set containing eight coordinate values (0,1)→(0,2)→(1,3)→(2,3)→(3,2)→(3,1)→(2,0)→(1,0)→ . . . is generated with respect to (X1, X2). In view of above, there are eight chances to determine the change of coordinate with respect to the range of cursor moving on screen during one mouse movement cycle.

In the case that the resolution of a monitor has been adjusted from low resolution mode to high resolution mode prior to moving mouse, user can program the mouse driver for changing a predetermined movement ratio of mouse with respect to cursor. For example, as mouse moves a unit distance the number of pixels of cursor moved on screen is two times. This can reduce the movement distance of mouse as cursor moves from one position to the other position on screen. Also, there are eight chances to determine the change of coordinate with respect to the range of pixel of cursor moving on high resolution screen during one mouse movement cycle. Hence, the required number of pixels for determining the change of coordinate on a high resolution screen of cursor is the same as that on a low resolution screen. Hence, user still can position cursor on screen precisely, thus significantly increasing the resolution of mouse movement on screen.

As shown in FIGS. 7a and 7b, analog signals are converted into square waves with respect to four predetermined references. Coordinate values of (X1, X2) is cyclically changed, i.e., (1,0)→(2,0)→(3,1)→(3,1)→(3,2)→(2,3)→(2,3)→(1,3)→(0,2)→(0,2)→(0,1)→(1,0)→ . . . ,during one mouse movement cycle. Since, in reviewing to the above cyclically changed coordinate values, the distance to go through from one coordinate value to another coordinate value of one cursor is not the same during one mouse movement cycle. This may hinder the movement of cursor.

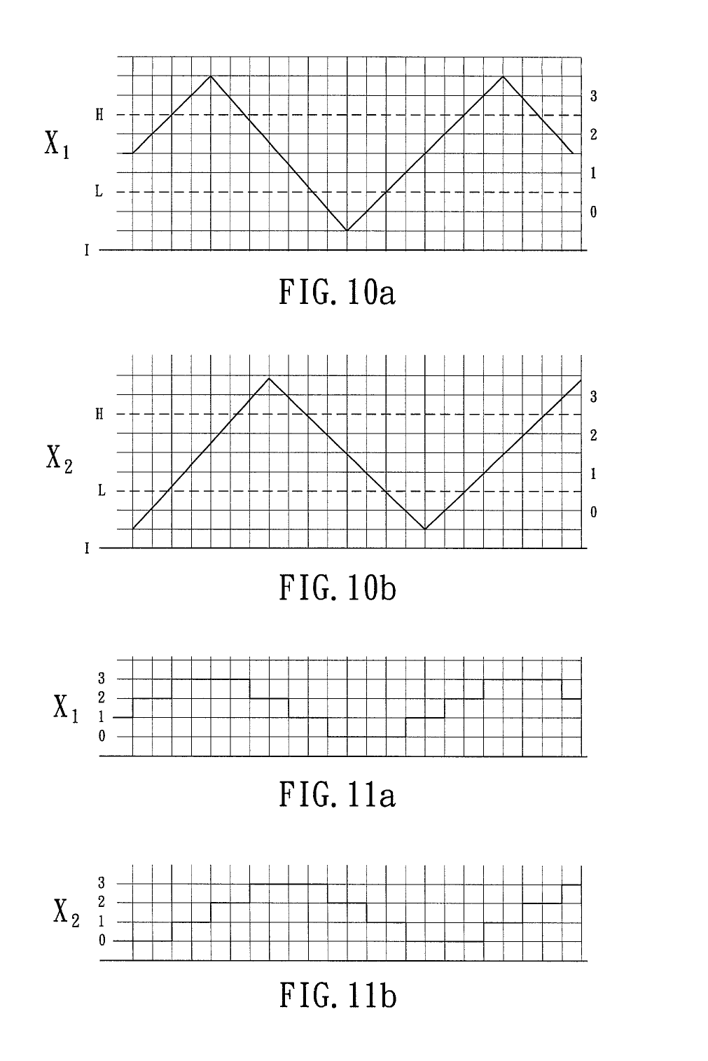

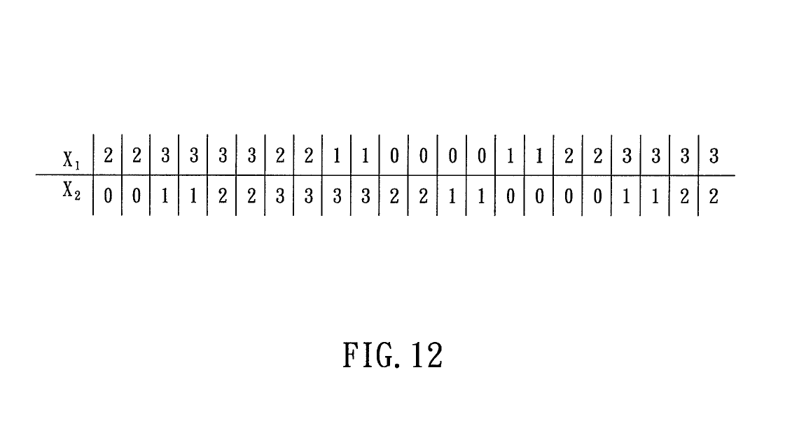

In a second preferred embodiment of the invention as shown in FIGS. 10a and 10b in conjunction with FIG. 9, two sequential analog signals detected by photodetectors 123 are sent to integral circuit 21 for converting into triangular signals. The triangular signals are in turn sent to ADC 23. Then ADC 23 performs an analog-to-digital conversion on the signals with respect to four predetermined references provided by control circuit 24. An integer is generated when the signal passes two adjacent references. Hence, a series of integer is generated in response to the analog signal. That is, a square wave is generated. This may be best illustrated in FIGS. 11a and 11b with respect to signals X1 and X2 respectively. Further, a coordinate comparison table is created with respect to above values in FIGS. 11a and 11b. As shown, coordinate values of (X1, X2) is cyclically changed, i.e., (2,0)→(2,0)→(3,1)→(3,1)→(3,2)→(3,2)→(2,3)→(2,3)→(1,3)→(1,3)→(0,2)→(0,2)→(0,1)→(0,1)→(2,0)→(2,0)→ . . . , during one mouse movement cycle. Hence, the distance to go through from one coordinate value to another coordinate value of one cursor is the same during one mouse movement cycle.

As shown in FIG. 9, control circuit 24 comprises a setting circuit for generating a variety of references. The setting circuit is electrically connected to a plurality of switches on switching circuit 25. As such, user may press a desired one of switches for causing control circuit 24 to generate a plurality of references in which the number of references in one setting may be different from that of the other setting. In one example there are at least three references generated by control circuit 24. Hence, ADC 23 may perform an analog-to-digital conversion on the analog signals with respect to the references respectively wherein a series of integer is generated when the analog signal passes two adjacent references. The series of integer is expressed as a step wave having a plurality of steps each representing an integer. A coordinate comparison table is created with respect to the integers of the step wave. Hence, there are at least six chances to determine the change of coordinate with respect to the cursor moving on screen during one mouse movement cycle. As a result, the resolution of mouse movement on screen is significantly increased.

While the invention has been described by means of specific embodiments, numerous modifications and variations could be made thereto by those skilled in the art without departing from the scope and spirit of the invention set forth in the claims.

What is claimed is:

1. A process for increasing resolution of a mouse movement on a computer screen, said process comprising the steps of:
a) moving a mouse to cause two beams of light emitted from light emitting elements to be detected by photodetectors;
b) converting said light into two sequential sinusoidal analog signals having a phase difference therebetween;
c) activating an analog-to-digital converter (ADC) to perform an analog-to-digital conversion on said analog signals with respect to at least three predetermined references respectively;
d) generating a series of integer in response to each analog signal passes two adjacent ones of said references;
e) representing said series of integer as a step wave having a plurality of steps each representing an integer; and
f) creating a coordinate comparison table with respect to said integers of said step wave, whereby there are at least six chances to determine change of coordinate with respect to a cursor moving on said screen during one movement cycle of said mouse.

2. The process of claim 1, wherein said step of b) further comprises the step of b1) activating an integral circuit to convert said detected analog signals by said light emitting elements into triangular signals prior to sending said triangular signals to said ADC.

3. The process of claim 1, further comprising a control circuit for generating said references so that said ADC is capable of performing said analog-to-digital conversion on said analog signals with respect to said references.

4. The process of claim 3, wherein said control circuit comprises a setting circuit for generating a plurality of different predetermined references and a switching circuit having a plurality of switches being electrically connected to said setting circuit so that one of said switches is operative to cause said control circuit to generate a plurality of predetermined references wherein number of said references in one generation is different from that of said other generation.

5. The process of claim 1, wherein said references are voltage levels.

6. The process of claim 1, wherein values of integers of said series of integer are increased progressively.
